(19) United States
(12) Patent Application Publication
(10) Pub. No.: US 2019/0110462 A1
(43) Pub. Date: Apr. 18, 2019

(54) LED RAT REPELLENT LIGHT

(71) Applicant: CLEAN CONCEPT, LLC, West Hollywood, CA (US)

(72) Inventors: Max Azria, West Hollywood, CA (US); Yasmine Hanane, West Hollywood, CA (US); Robert McFarlane, West Hollywood, CA (US)

(21) Appl. No.: 15/847,178

(22) Filed: Dec. 19, 2017

(30) Foreign Application Priority Data
Oct. 18, 2017 (CN) 201721341700.2

(51) Int. Cl. A01M 29/18; F21K 9/237; F21V 3/02; F21K 9/232; F21K 9/238; F21V 7/04; F21V 23/00; F21V 19/00; F21V 29/83; F21V 11/00; F21K 9/235; F21V 15/01; F21V 17/12; G10K 13/00; G10K 11/20

(52) U.S. Cl. CPC A01M 29/18; F21Y 2115/10; F21V 3/02; F21K 9/232; F21K 9/238; F21V 7/041; F21V 23/003; F21V 19/0015; F21V 29/83; F21V 11/00; F21K 9/235; F21V 15/01; F21V 17/12; G10K 13/00; G10K 11/20; F21K 9/237

(57) ABSTRACT

The present disclosure provides a LED rat repellent light, comprising an LED assembly, a rat repellent assembly and a light socket, wherein the rat repellent assembly is arranged between the LED assembly and the light socket. The rat repellent assembly comprises: a connecting shell having a first connecting shell end and a second connecting shell end. The rat repellent assembly also includes a middle frame having a first frame end, a second frame end, and a side wall. The first connecting shell end is connected to the light socket, the second connecting shell end is connected to the first frame end, and the second frame end is connected to the LED assembly. The middle frame further comprises at least one opening arranged on the side wall thereof. The rat repellent assembly further includes an ultrasound emitter, arranged in the connecting shell, wherein the ultrasound emitter has an surface facing the middle frame. The rat repellent assembly also includes a reflective panel, arranged in the middle frame, wherein the reflective panel has a first side extruding towards the ultrasound emitter. In operation, ultrasound output from the ultrasound emitter is reflected on the first side of the reflective panel and then passes through the opening on the middle frame.

### CROSS-REFERENCE

This application is based upon and claims the benefit and priority of Chinese Patent Application No. 201721341700.2, filed on Oct. 18, 2017, the entire contents of which are incorporated herein by reference.

### TECHNICAL FIELD

The present disclosure belongs to the field of LED lights, specifically to a LED rat repellent light.

### BACKGROUND

LED light is a semiconductor device to convert electrons to photons by PN junctions, and emits light directly without heating process. As LED light has the properties of energy conservation, environmental protection and long life, it has been widely applied as a new kind of lighting source. However, the LED light in the existing technology usually has a single function, therefore it may not realize more efficiency while occupying a certain space.

### SUMMARY

The primary object of the present disclosure is to provide an LED rat repellent light, with functions of repelling animals and LED lighting, wherein animals such as rats, mice, or other rodents may be effectively repelled by ultrasound from an ultrasound emitter.

The present disclosure provides a LED rat repellent light, comprising an LED assembly, a rat repellent assembly and a light socket, wherein the rat repellent assembly is arranged between the LED assembly and the light socket. The rat repellent assembly comprises: a connecting shell having a first connecting shell end and a second connecting shell end. The rat repellent assembly also includes a middle frame having a first frame end, a second frame end, and a side wall. The first connecting shell end is connected to the light socket, the second connecting shell end is connected to the first frame end, and the second frame end is connected to the LED assembly. The middle frame further comprises at least one opening arranged on the side wall thereof. The rat repellent assembly further includes an ultrasound emitter, arranged in the connecting shell, wherein the ultrasound emitter has a surface facing the middle frame. The rat repellent assembly also includes a reflective panel, arranged in the middle frame, wherein the reflective panel has a first side extruding towards the ultrasound emitter. In operation, ultrasound output from the ultrasound emitter may be reflected on the first side of the reflective panel and then passes through the opening on the middle frame.

On that account, the LED rat repellent light in a compact structure, provides functions of repelling animals and LED lighting simultaneously or alternatively. Animals such as rats, mice, other rodents, birds and mosquitoes may be repelled by ultrasound output from the ultrasound emitter. In addition, a light may be placed into the light socket without adding other electrical components. As such, the LED rat repellent light may be applied more easily and widely.

### BRIEF DESCRIPTION OF THE FIGURES

By reading the detailed description made to non-limiting embodiments referring to the following figures, the other features, objects and advantages will be more apparent.

FIG. 1 is a stereoscopic schematic view of the LED rat repellent light according to an embodiment of the present disclosure;

FIG. 2 is an explosive view of the LED rat repellent light according to the embodiment of the present disclosure;

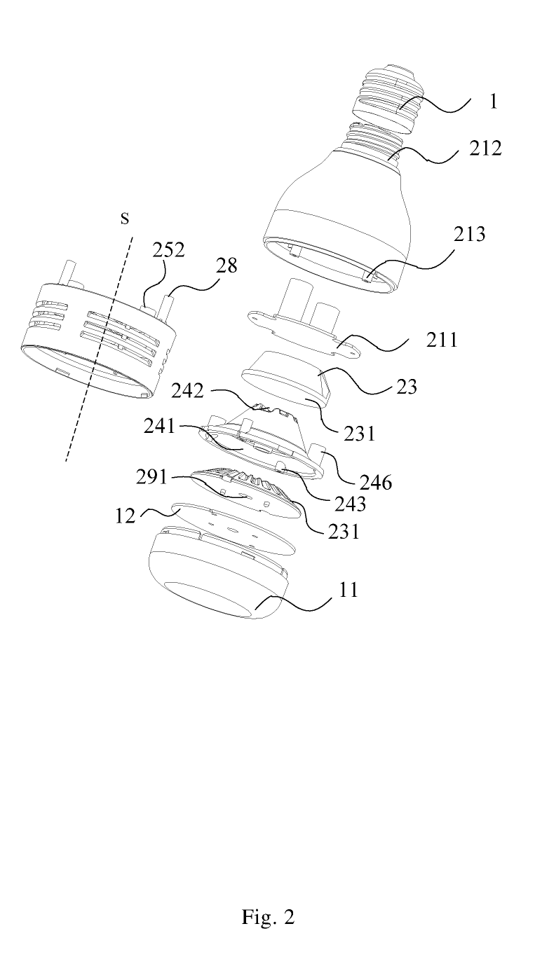

FIG. 3 is a top view of the LED rat repellent light according to the embodiment of the present disclosure;

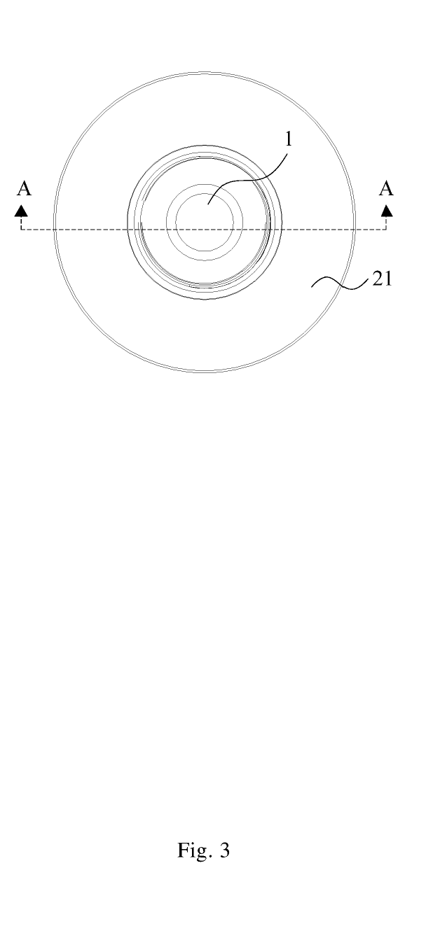

FIG. 4 is a cross-section view from direction A-A of FIG. 3;

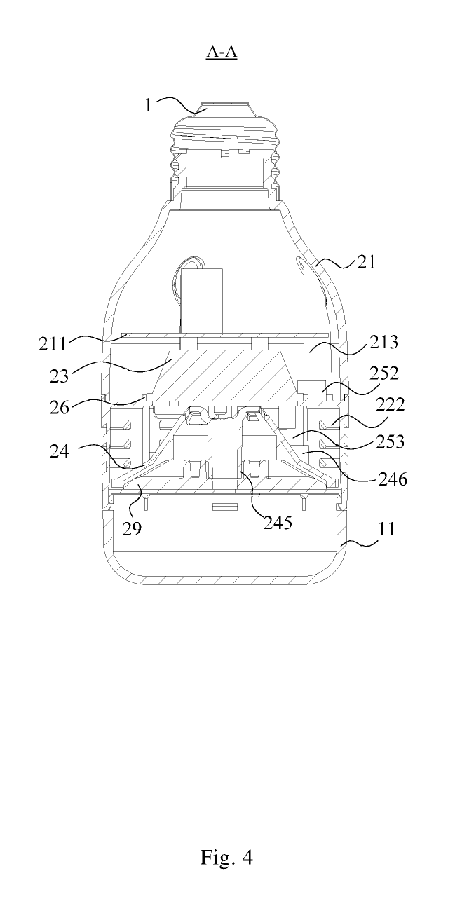

FIG. 5 is a schematic view of the combination of a middle frame and a reflective panel according to the embodiment of the present disclosure;

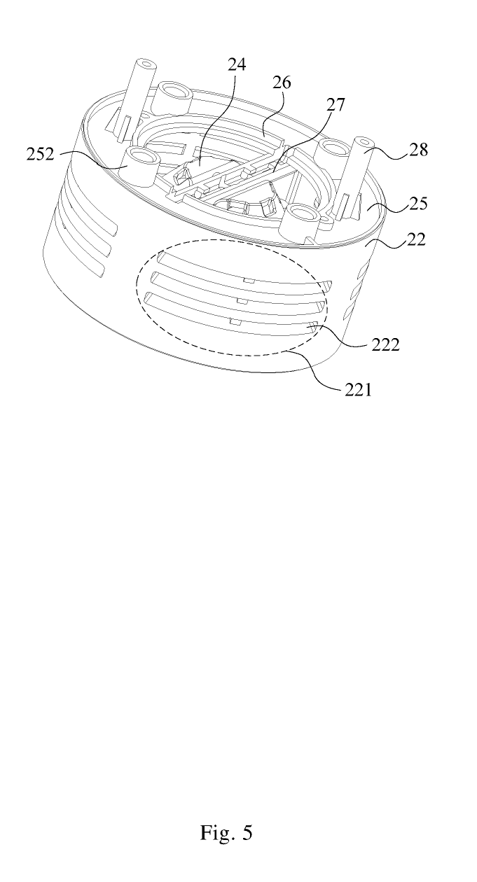

FIG. 6 is a schematic view of the opening angle of the middle frame according to the embodiment of the present disclosure;

FIG. 7 is a schematic view of the middle frame according to the embodiment of the present disclosure;

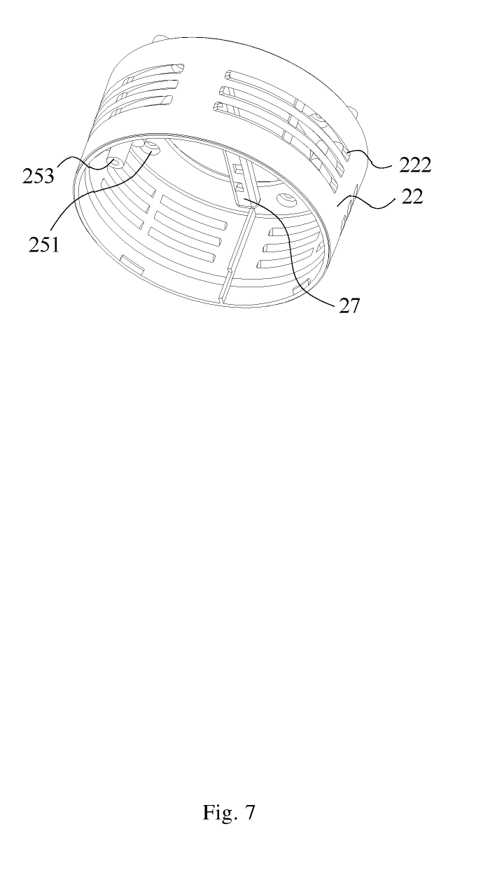

FIG. 8 is a schematic view of the reflective panel according to the embodiment of the present disclosure;

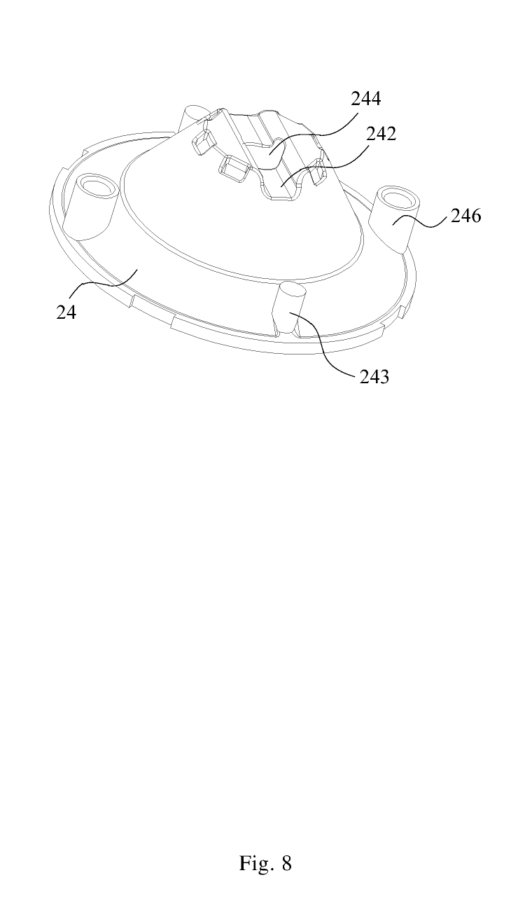

FIG. 9 is another schematic view of the reflective panel according to the embodiment of the present disclosure;

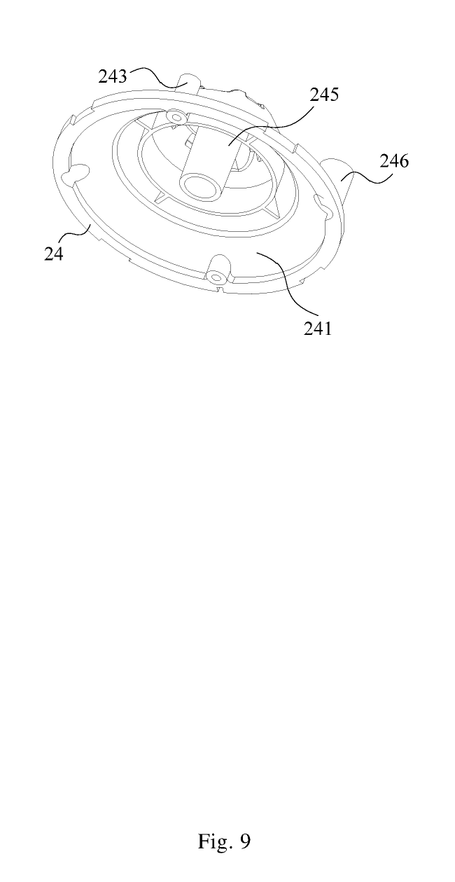

FIG. 10 is a cross-section view of the combination of the ultrasound emitter, the middle frame and the reflective panel according to the embodiment of the present disclosure;

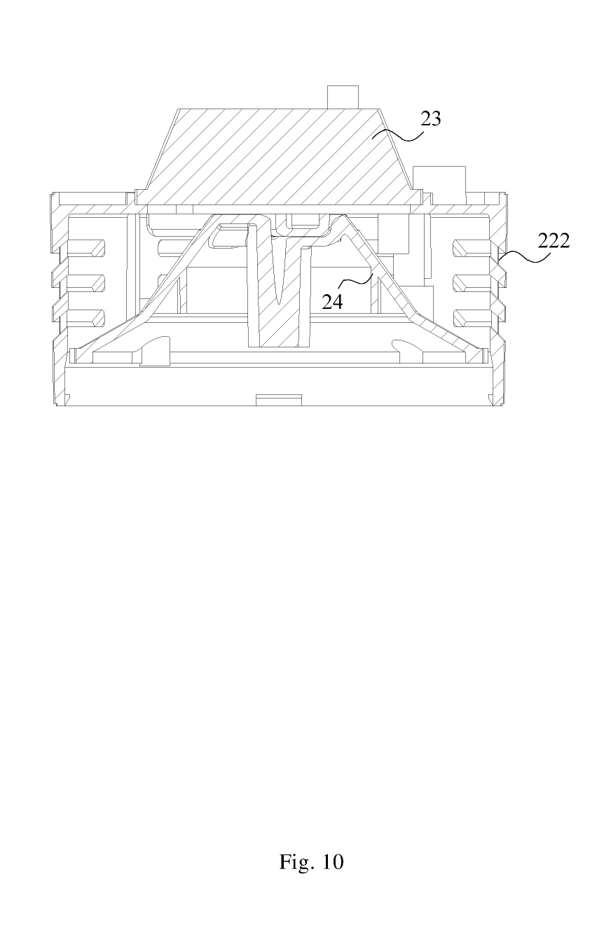

FIG. 11 shows the travel path of the ultrasound output from the ultrasound emitter according to the embodiment of the present disclosure; and

FIG. 12 is a schematic view of the heat emission panel according to the embodiment of the present disclosure.

### DETAILED DESCRIPTION OF THE PREFERRED EMBODIMENTS

Hereinafter, the example embodiments are described in detail with reference to the Figures. However, the example embodiments may be implemented in many forms, and shouldn't be understood to be limited by the implement method described herein. Rather, the present disclosure may be more complete and by providing these embodiments and the conception of the embodiments may be transferred to the skilled in the art in the general. The same reference numbers may be directed to same or similar structures, therefore repeated description of them will be omitted.

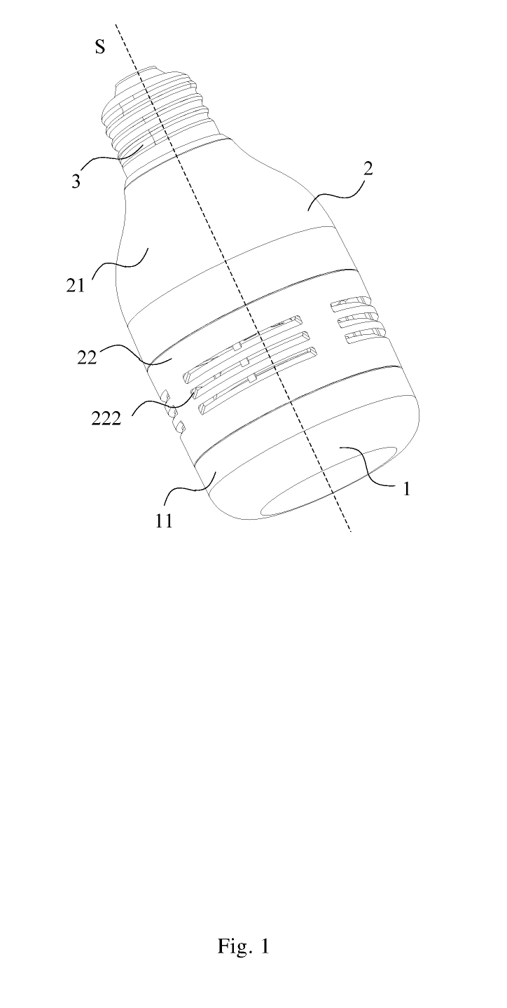

Shown in FIGS. 1˜12, an embodiment of the present disclosure provides an LED rat repellent light, including an LED assembly 1, a repellent assembly 2 to repel rats with ultrasound and a light socket 3. The repellent assembly 2 arranged between the LED assembly 1 and the light socket 3 includes: a connecting shell 21, a first end thereof connected to the light socket 3; a middle frame 22, a first end thereof connected to a second end of the connecting shell 21, a second end of the middle frame 22 connected to the LED assembly 1. At least one opening may be arranged on a side wall of the middle frame 22, to guide ultrasound to emit outside. An ultrasound emitter 23 may be arranged inside the connecting shell 21 and a reflective panel may be arranged inside the connecting shell 21. The connecting shell 21 connects the middle frame 22 and the light socket 3. The connecting shell 21 and the middle frame 22 are two separate parts, or are molded in one part. The emitting surface 231 of the ultrasound emitter faces the middle frame 22. A first side of the reflective panel 24 faces the ultrasound emitter 23 and extrudes towards the ultrasound emitter 23. As such, the ultrasound from the ultrasound emitter 23 may be reflected by the reflective panel, and then passes through the opening 222 of the middle frame 22.

In an embodiment, the LED assembly 1 and the rat repellent assembly 2 are combined together subtly. The ultrasound emitter 23 emits ultrasound in a certain frequency, which repels some animals like rats, mice and other rodents. Therefore, the light realizes functions of LED lighting and rat repelling. For example, to repel rats, the ultrasound emitter emits ultrasound in a frequency of 20 kHz-55 kHz. In the embodiment, the ultrasound frequency may be up to 40 kHz. The light may also be used to repel mosquitoes by using an ultrasound emitter in a frequency higher than 20 kHz, to imitate the sound wave of mosquitoes' enemies, such as bats, dragonfly and so on. Ultrasound higher than 20 kHz may be barely heard by human ears. Therefore, the ultrasound has no influence on humans.

Ultrasound may cause certain harm to plastic pieces or circuit components. If the ultrasound emitter 23 emits the ultrasound vertically downwards, the ultrasound will directly pass through the LED assembly 1 and cause damage to the plastic pieces or circuit components therein. In the embodiment, the reflective panel 24 reflects the ultrasound to the side wall of the middle frame to emit the ultrasound through the openings 222, rather than passing through the LED circuit board. Therefore, the LED assembly 1 may be well protected.

In one embodiment, the light socket 3 may be a screw socket, such as a screw socket of E26, E27 or other models, which may be directly connected to an existing socket. Therefore, the LED rat repellent light may replace the existing LED light bulb without increasing or changing any electric components.

Further, in one embodiment, the middle frame 22 may be cylindrical. A plurality of opening sections 221 are arranged on the side wall of the middle frame 22 and are distributed uniformly along the peripheral direction of the middle frame 22. The openings 222 in a same opening section 221 are sequenced along an axial direction S of the middle frame 22. In the embodiment, the LED assembly 1 and the connecting shell 21 have a same axis aligned with the axis of the middle frame 22, but the present disclosure is not limited to that. In the embodiment, four opening sections are distributed uniformly, and each opening section has three openings, to have a better rat repellent effect. In a case of long opening, a small support cylinder, connected to the upper side and the lower side of each opening 222, may be added in each opening 222. The numbers and distribution form of the opening sections 221, the numbers and distribution form of the openings 222 in each opening section 221 may be adjusted, which are all within the protection scope of the present disclosure. For example, four openings 222 are arranged in each opening section 221, or each opening 222 extends along the axial direction S.

In an embodiment, the openings 222 are formed by processing directly on the side wall of the middle frame 22. In other embodiments, a big hole may be opened on the side wall of the middle frame 22 corresponding to each opening section 221, then a structural component with a plurality of openings and in a specific shape may be inserted in the big hole. The structural component may be an elastic plastic component and cooperates with the inner wall of the big hole, to facilitate the detachment and cleaning for users. For example, for the LED rat repellent light with four opening sections, four big holes distributed uniformly are opened up on the side wall of the middle frame, with a plastic component detachably mounted in each big hole.

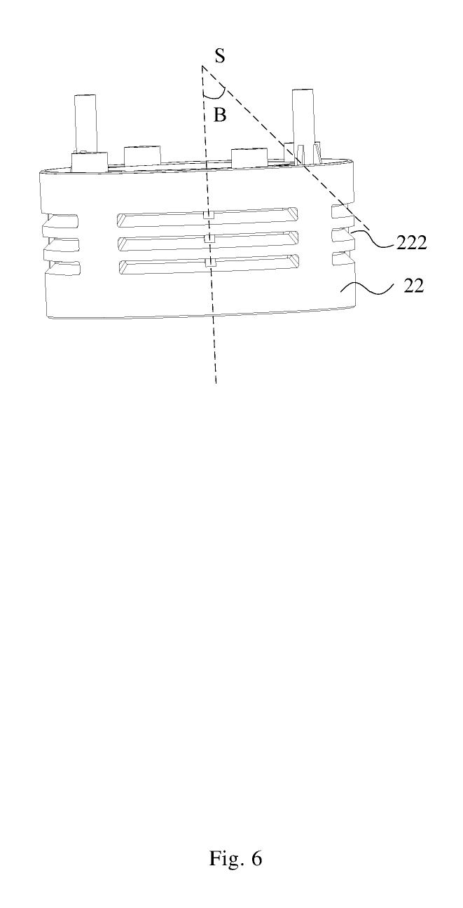

Further, the two side walls of the opening 222 along the peripheral directions of the middle frame are parallel to each other, and each side wall of the opening has an angle of 30°-60° with the axial direction S. The first side and the second side of each opening 222 extend along the peripheral direction of the middle frame, and adjoin the inner surface and the outer surface of the side wall of the middle frame 22, respectively. The first side may be closer to the connecting shell 21 than the second side of the opening 222. Shown in FIG. 6, the two side walls of the opening 222 refer to the upper side wall and lower side wall of the opening 222, which have an angle B of 30°-60° with the axial direction S. In a certain embodiment, the angle B may be 45°. Therefore, the ultrasound from the ultrasound emitter 23 may be reflected on the reflective panel, and then passes through the opening 222 to emit downwards in an angle of 45°. When the light may be mounted to at high position like the ceiling through the screw socket 3, the ultrasound diffuses downwards in an angle of 45° to reach each corner of a room. In other embodiments, the angle B may be not limited to 30°-60° and may be selected according to different cover areas of ultrasound.

The structure above is one of the embodiments of the present disclosure, and the scope of the present disclosure is not limited to this, other variants and combinations may also be realized. For example, when the LED rat repellent light may be connected to a lower position like the ground, the upper side wall and the lower side wall of the opening 222 incline upwards, that is, the second side of the side wall of the opening 222 may be closer to the connecting shell 21 than the first side. Therefore, the ultrasound may be guided by each opening to diffuse upwards in a certain angle, and then reaches each corner of the room.

Further, an annular connecting panel 25 may be arranged on the first end of the middle frame 22, and the first side of the connecting panel 25 facing the ultrasound emitter 23 may be provided with a spacing ring 26 having a same axis with the middle frame 22. The emitting surface 231 partially contacts with the connecting panel 25, and the outer surface of the ultrasound emitter 23 contacts with the inner surface of the spacing ring 26. The connecting panel 25 may be molded in one part with the side wall of the middle frame 22, or, the connecting panel 25 may be a single annular panel welded with the middle frame 22. The connecting panel 25 retracts a small distance inwards compared to the side wall of the middle frame 22, but the present disclosure is not limited to this. Similarly, the spacing ring 26 may be molded in one part with the connecting panel 25, or, the spacing ring 26 may be a single ring welded or fastened to the connecting panel 25. The spacing ring 26 limits the position of the ultrasound emitter 23 to avoid movements in any direction. In other embodiments, the position limitation of the ultrasound emitter 23 may be realized in other methods, such as arranging a plurality of spacing cylinders to limit the position of the emitter 23.

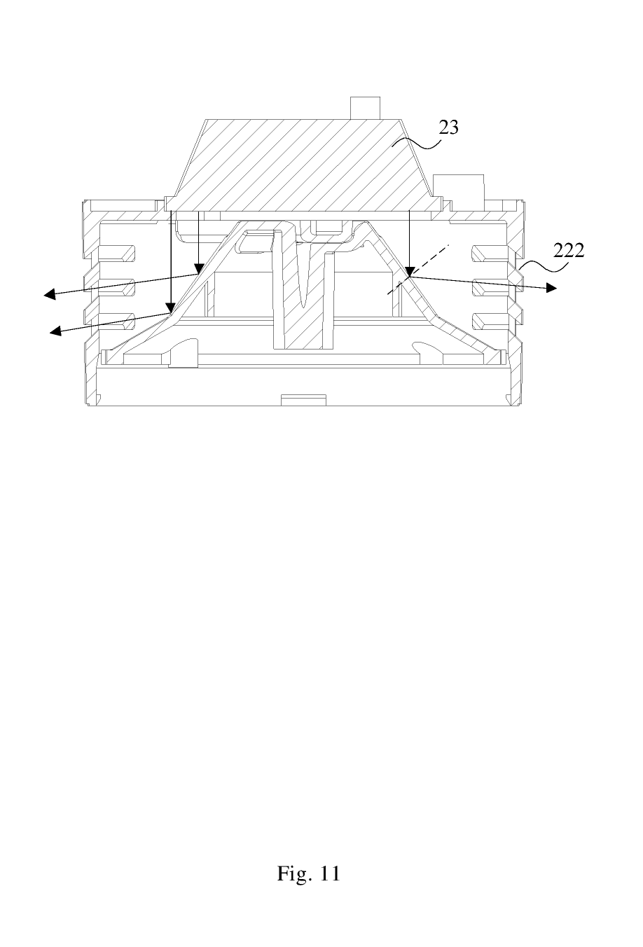

In an embodiment, a supporting rod 27 may be arranged on the second side of the connecting panel 25. There may be a groove 242 in the middle of the first side of the reflective panel 24. The supporting rod 27 may be inserted in the groove 242 to connect the reflective panel 24 with the middle frame 22, and then limit the position of the reflective panel 24. There may be a certain distance between the ultrasound emitter 23 and the reflective panel 24, and the reflective panel 24 may be arranged right below the emitter 23, to reflect the ultrasound from the emitter 23 to the opening 222. The travel path of the ultrasound is shown in FIG. 11. The incline direction and incline angle of the upper and lower side walls of the opening 222 decide the emitting direction.

In an embodiment, a control board 211 arranged inside the connecting shell 21 may be connected to the power supply through the light socket 3 and may be connected to the ultrasound emitter 23, to control the working state of the emitter 23. The LED assembly 1 includes a light shade 11 and a LED circuit board 12 in the light shade 11. The control board 211 may be connected to the LED circuit board 12 through electric wires, to control the working state of the LED light. In the embodiment, the ultrasound emitter 23 and the LED circuit board are controlled respectively. The users may choose to only open the LED light, to only open the ultrasound emitter 23 or to open the LED light and the ultrasound emitter 23 at the same time.

In an embodiment, the first side of the connecting panel 25 may be provided with at least one supporting cylinders 28, which contact with the control board 211. At least one threading hole 251 may be opened on the surface of the connecting panel 25, and at least one threading cylinder 243 may be arranged at the edge of the connecting panel 25 corresponding to the threading hole 251. The electric wires pass through the threading cylinder 243 and the threading hole 251 in turn to connect to the control board 211. In other embodiments, other threading methods may be adopted, and are without any doubt within the scope of the present disclosure. For example, the threading hole and the threading cylinder may be arranged in other positions, to guide the electric wires from the LED circuit board 12 to the control board 211, or the electric wires may pass through the middle of the light.

In one embodiment, the reflective panel 24 may be a funnel extruding towards the ultrasound emitter 23. There may be a cavity 241 on the second side of the reflective panel 24 facing the LED assembly 1. There may be a first heat emission hole 244 opened in the middle of the reflective panel 24. In the cavity, there may be a heat emission panel 29 with a second heat emission hole 291 arranged in the middle. The heat emission panel 29 has a function of heat emission for the LED assembly 1, and has another function of flattening the contact surface between the reflective panel 24 and the LED circuit board 21. The first hole 244 and the second hole 29 guarantee the air circulation in the entire LED rat repellent light. In other embodiments, more small holes may be opened around the first hole 244 to have a better heat emission effect and prolong the working hours of the light.

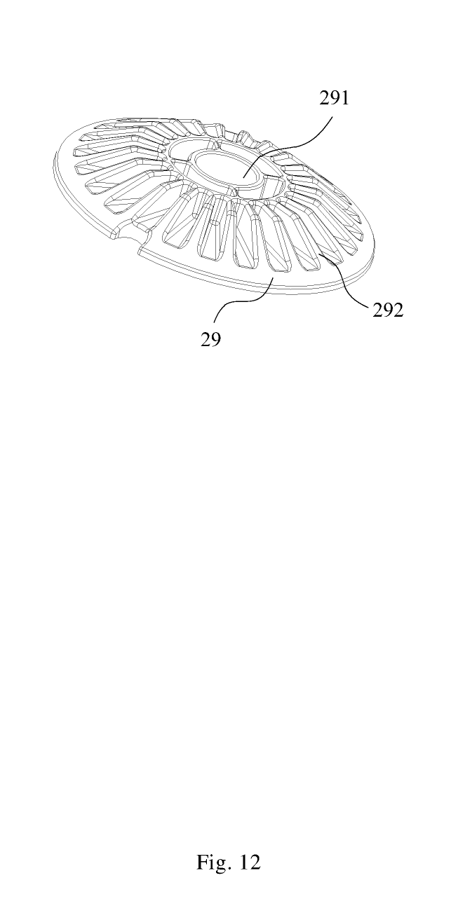

In one embodiment, a heat emission tube 245 arranged in the middle of the cavity 241 may be connected to the first hole 244 and passes through the second hole 291. In other embodiments, a heat emission tube arranged on the first side of the heat emission panel 29 may be connected to the second hole 291 and passes through the first hole 244. With the connection between the heat emission tube and the heat emission holes, the relative location of the reflective panel 24 and the heat emission panel 29 may be limited. Further, shown in FIG. 12, the first side of the heat emission panel 24 may be provided with a plurality of flanges 202, which distributed uniformly on the surface of the heat emission panel 29, and the surface of each flange at least partially contacts with the inner surface of the cavity 241, to realize a better structural cooperation between the heat emission panel 29 and the reflective panel 24. The flange 292 and the cavity 241 contact with each other directly to transfer heat from a hotter position to a colder position.

The heat emission panel 20 doesn't fully fill the cavity 241, and therefore the reflective panel 24 may be hollow. One role of the arrangement is to have a better heat emission effect, another role is to save materials and to have a light entire weight of the light.

Further, the panel 29 has the function of heat emission not only for the LED assembly 1, but also for the reflective panel 24. With the irradiation of the ultrasound towards the reflective panel 24 for a long time, the temperature of the panel 24 may rise for the high energy of the ultrasound. Therefore, the panel 29 also guarantees longer working hours of the rat repellent assembly 2.

In another embodiment of the present disclosure, an opening corresponding to the position of the heat emission hole may be opened in the middle of the light shade. The opening connects to the heat emission hole through a connecting tube. The LED circuit board may be an annular circuit board around the connecting tube. With this arrangement, the ultrasound not only emits outside through the side wall of the middle frame 22, but also emits through the emission tube 245 and the connecting tube vertically downwards. The connecting tube may be formed by the materials with a good shielding effect for ultrasound, like metal, to shield the annular circuit board and the ultrasound, and then protect the LED assembly 1. Another role of the arrangement is to have a better heat emission effect for the entire light as the opening on the light shade is connected to the environment. In some cases, a cover, with no shielding effect for ultrasound, may be added outside the light shade for dust prevention.

In the case that the light socket 3 may be a screw socket, a screw part 212 may be arranged on the first end of the connecting shell 21 to cooperate with the screw socket, and the inner thread of the screw socket cooperates with the outer thread of the screw part 212. The screw part 212 may be hollow and one end opens towards the screw socket. Therefore, the control board 211 connects to the screw socket through electric wires passing through the screw part 212. Further, one or more threading tubes extending along the axial direction S are arranged on the surface of the control board 211 facing the screw socket, wherein the wires pass through the threading tube to connect to the electric contacts of the screw socket. With this arrangement, the light socket 3 and the connecting shell 21 are connected together or detached apart easily, to facilitate the examination and replacement of each component. In other embodiments, the connection relationship between the light socket 3 and the connecting shell 21 varies, and different variations are all within the scope of the present disclosure. For example, the light socket 3 may be welded to the connecting shell 21 directly without the screw part 212.

In other embodiments, the light socket 3 may not be limited to the screw socket in the embodiment. For example, the light socket 3 may be a part with a rechargeable battery inside, then the LED rat repellent light doesn't depend on external power source, and realizes the functions of lighting and rat repelling with its own power supply. In other embodiments, the light socket 3 may be a regular three-phase plug or a two-phase plug, the plug connects to other parts of the LED rat repellent light through electric wires.

The inner surface of the connecting shell 21 may be provided with at least one first connecting cylinder 213, and the first end of the middle frame may be provided with second connecting cylinders 252 in one-to-one correspondence with the first connecting cylinder 213. The first connecting cylinder 213 may be inserted into corresponding second connecting cylinder 252, or vise versa, to connect the connecting shell 21 to the middle frame 22. In other embodiments, the connecting shell 21 and the middle frame 22 may also be combined with threaded connection; or the connecting shell 21 and the middle frame 22 are molded in one body. Other variations are also within the scope of the present disclosure.

The middle frame 22 may be provided with at least one third connecting cylinder 253, and the first side of the reflective panel 24 may be provided with at least one fourth connecting cylinder 246 in one-to-one correspondence with the third connecting cylinder 253. The third connecting cylinder 253 may be inserted into the corresponding fourth connecting cylinder 24 to connect the middle frame 22 with the reflective panel 24. In other embodiments, the middle frame 22 may also be fastened to the reflective panel 24 or be welded to the reflective panel 24. The middle frame 22 and the reflective panel 24 may also be molded in one body. The different variations are all within the scope of the present disclosure.

On that account, the LED rat repellent light in a compact structure, provides functions of repelling animals and LED lighting simultaneously or alternatively. Animals such as rats, mice, other rodents, birds and mosquitoes may be repelled by ultrasound output from the ultrasound emitter. In addition, a light may be placed into the light socket without adding other electrical components. As such, the LED rat repellent light may be applied more easily and widely.

The series of specific illustrations listed above are only specific illustrations aiming at the methods for feasibility embodiments. They are not used as a limitation to the protection scope of the present disclosure, equivalent embodiments or alterations made without being apart from the art spirit of the present disclosure should all be included in the protection scope of the present disclosure.

What is claimed is:

1. An LED rat repellent light, comprising an LED assembly, a rat repellent assembly and a light socket, wherein the rat repellent assembly is arranged between the LED assembly and the light socket, wherein the rat repellent assembly comprises:
a connecting shell having a first connecting shell end and a second connecting shell end;
a middle frame having a first frame end, a second frame end, and a frame side wall positioned therebetween, wherein the frame side wall has an inner surface and an opposing outer surface;
wherein the first connecting shell end is connected to the light socket, the second connecting shell end is connected to the first frame end, and the second frame end is connected to the LED assembly;
at least one opening arranged on the side wall of the middle frame;
an ultrasound emitter positioned in the connecting shell, wherein the ultrasound emitter includes an emitting surface positioned facing the middle frame; and
a reflective panel positioned in the middle frame, wherein the reflective panel includes a first side extruding towards the ultrasound emitter;
wherein ultrasound from the ultrasound emitter is reflected on the first side of the reflective panel and then passes through the at least one opening on the side wall of the middle frame.

2. The LED rat repellent light according to claim 1, wherein, the middle frame is cylindrical, wherein a plurality of opening sections are arranged on the frame side wall, and the opening sections are distributed uniformly along a peripheral direction of the middle frame;
wherein each opening section includes at least one opening therein, wherein each opening extends along the peripheral direction of the middle frame, and each opening located in a same opening section are sequenced along an axial direction of the middle frame.

3. The LED rat repellent light according to claim 2, wherein
each opening has two opening side walls, wherein the two opening side walls extend along the peripheral direction and are parallel to each other, wherein each opening side wall has an angle of 30°˜60° with the axial direction of the middle frame;
wherein each opening side wall has a first side and a second side, wherein the first side is adjacent to the inner surface of the frame side wall and the second side is adjacent to outer surface of the frame side wall, the first side of each opening side wall is closer to the connecting shell than the second side of each opening side wall.

4. The LED rat repellent light according to claim 2, wherein, the middle frame is cylindrical, the rat repellent assembly further comprises
an annular connecting panel arranged on the first frame end, and
a spacing ring arranged on a first side of the connecting panel facing the ultrasound emitter,
wherein the emitting surface of the ultrasound emitter partially contacts the connecting panel, and an outer surface of the ultrasound emitter contacts with the inner surface of the spacing ring.

5. The LED rat repellent light according to claim 4, wherein the rat repellent assembly further comprises;
a supporting rod arranged on a second side of the connecting panel,
a groove is arranged in the middle of the first side of the reflective panel,
wherein the supporting rod is configured to be inserted into the groove.

6. The LED rat repellent light according to claim 4, wherein the rat repellent assembly further comprises a control board arranged in the connecting shell, wherein the control board is configured to be connected to a power source through the light socket and to be connected to the ultrasound emitter;
wherein the LED assembly further comprises a light shade and a LED circuit board arranged in the light shade, wherein the LED circuit board configured to be connected to the control board via connection wires;
wherein the rat repellent assembly further comprises at least one supporting cylinder is arranged on the first side of the connecting panel facing the ultrasound emitter, the supporting cylinder contacts with the control board.

7. The LED rat repellent light according to claim 6, wherein the rat repellent assembly further comprises:
at least one threading hole is arranged on the connecting panel,
at least one threading cylinder is arranged on an edge of the reflective panel, wherein the threading cylinder and the threading hole are in one-to-one correspondence, and connection wires pass through the threading cylinder and threading hole to connect to the control board.

8. The LED rat repellent light according to claim 1, wherein, the reflective panel is a funnel extruding towards the ultrasound emitter, wherein the reflective panel further comprises a cavity formed on a second side of the reflective panel, a first heat emission hole in the middle of the reflective panel, a heat emission panel arranged in the cavity, and a second heat emission hole in the middle of the heat emission panel.

9. The LED rat repellent light according to claim 8, wherein the rat repellent assembly further comprises a heat emission tube arranged in the middle of the cavity, wherein the heat emission tube is configured to be connected to the first heat emission hole and pass through the second heat emission hole.

10. The LED rat repellent light according to claim 8, wherein the rat repellent assembly further comprises a heat emission tube arranged in the middle of the cavity, wherein the heat emission tube is configured to be connected to the second heat emission hole and pass through the first heat emission hole.

11. The LED rat repellent light according to claim 8, wherein, a plurality of flanges are formed uniformly on a first side of the heat emission panel, and surfaces of the flanges at least partially fit closely to the inner surface of the cavity;
wherein the LED assembly comprises a light shade and a LED circuit board in the light shade, wherein a second side of the heat emission panel fits closely to the LED circuit board.

12. The LED rat repellent light according to claim 11,
wherein the light shade further comprises an opening corresponding to the position of the first heat emission hole, and a connecting tube arranged to connect the opening in the light shade to the first heat emission hole;
wherein the LED circuit board is an annular circuit board configured to shelter part of the connecting tube.

13. The LED rat repellent light according to claim 1, wherein the light socket further comprises a screw socket, wherein the first connecting shell end comprises a screw part configured to cooperate with the screw socket, wherein the screw socket is configured to shelter the screw part, and wherein an inner cavity of the screw part is connected with an inner cavity of the screw socket.

14. The LED rat repellent light according to claim 1, wherein the rat repellent assembly further comprises at least one first connecting cylinder arranged in the connecting shell, at least one second connecting cylinder in one-to-one correspondence with the first connecting cylinder arranged on the first frame end, wherein at least one of the first connecting cylinder and the second connecting cylinder are configured to be inserted into the other connecting cylinder.

15. The LED rat repellent light according to claim 1, wherein the rat repellent assembly further comprises at least one third connecting cylinder arranged in the middle frame, at least one fourth connecting cylinder in one-to-one correspondence with the third connecting cylinder s arranged on the first side of the reflective panel, wherein at least one of the third connecting cylinder and the fourth connecting cylinder are configured to be inserted into the other connecting cylinder.

16. An LED rat repellent light, comprising an LED assembly, a rat repellent assembly and a light socket, wherein the rat repellent assembly is arranged between the LED assembly and the light socket, wherein the rat repellent assembly comprises:
a connecting shell, a first end of the connecting shell connected to the light socket;
a middle frame, a first end of the middle frame connected to a second end of the connecting shell, a second end of the middle frame connected to the LED assembly, at least one opening arranged on a side wall of the middle frame;
an ultrasound emitter, arranged in the connecting shell, and an emitting surface of the ultrasound emitter facing the middle frame;
a reflective panel, arranged in the middle frame, a first side of the reflective panel extruding towards the ultrasound emitter;
ultrasound from the ultrasound emitter is reflected on the first side of the reflective panel and then passes through the opening on the middle frame.
